(19) United States
(12) Patent Application Publication
(10) Pub. No.: US 2014/0138940 A1
(43) Pub. Date: May 22, 2014

(54) Integrated Maze Bead Toy Attached to Stroller Bumper Bars

(71) Applicant: Fateha Khanam Chowdhury, Ilford (GB)

(72) Inventor: Fateha Khanam Chowdhury, Ilford (GB)

(21) Appl. No.: 13/679,050

(22) Filed: Nov. 16, 2012

(51) Int. Cl. B62B 9/24

(52) U.S. Cl. CPC B62B 9/245
USPC 280/748

(57) ABSTRACT

The Integrated maze bead toy is developed using a hollow insertion created within the bumper bar 5, can have a rod system 3 with balls having holes through the centre so the rod 3 for the balls 2,4 and 6 to travel through from one end of the bumper bar to the other.

The balls integrated in the bumper bar travel through the channel of the bumper bar (the hollow insertion) without the need for the rod system 3. The bumper bar has a unique way of keeping the balls intact allowing the balls to travel and make their journey from one end of the bumper bar to the other freely.

According to the present invention there is provided a combined stroller bumper bar and bead toy comprising: a bumper bar having a channel formed therein and extending the length thereof, the bumper bar being attachable at both ends thereof to a stroller, and; a plurality of beads held within the channel and being arranged to move freely within the channel; the arrangement being such that a child seated in the stroller may manipulate the beads in order to push the beads along the channel.

Nowadays strollers/buggys/prams lack an entertainment feature to soothe the child. This toy is an educational toy, either teaching the child colours of the rainbow and primary colours such as red, yellow, blue, green. A maze bead toy inserted through the bumper bar, includes a rod/wire (3) in the bumper bar for the beads that is of substantially uniform cross-sectional configuration over its entire length and is configured to also form multiple curves either with the wire/rod (3). A carriage which has it's own shape of different styles of valleys which makes the wire/rod slidable along the bumper bar (5). A channel structure has two ends connected to the two slider members respectively integrated within the bumper bar, see drawing.

The integrated maze bead toy having a channel structure to form the unique styles of valleys to keep the balls (2,4 and 6) intact and simultaneously allow them to freely flow along the bumper bar without a rod system, an invention to make it possible for balls to move and slide freely from one end of the bumper to the other so as to mimic the 10 pin bowling balls found in amusement centre's integrated inside the stroller bumper bar.

The integrated maze bead bumper toy can also have the option of having electronic lights and a multifunctional button system (2,4 and 6). The toy in particular relating to this invention may contain chimes and buttons in the bead's. This invention is purely created for the entertainment and educational purpose which meets pre-school educational quality in particular providing eye co-ordination techniques (FIGS. 2,4 and 6) for early learning.

This invention can be given the credit to a fixed toy system to providing better alternative than loose toy's placed in front of the child which has a repetitive habit of falling out of the stroller.

1. Each bead would be red, FIG. 2 drawing 1, blue, FIG. 2 drawing 1 and yellow, FIG. 6 drawing 1 repeated 3 times over in the rod totaling to 12, the balls could have the possibility of having lights and sound, see FIGS. 2,4 and 6 drawing 1. May have the potential to also have other colours of the rainbow

2. The rod would be spiral shaped, rod can be of steel/aluminium/metal, see FIG. 3 drawing 1.

3. Each bead can be easily pushed to one end of the bumper bar of stroller to the other to perform the entertainment, see FIG. 5 drawing 1.

Drawing 1

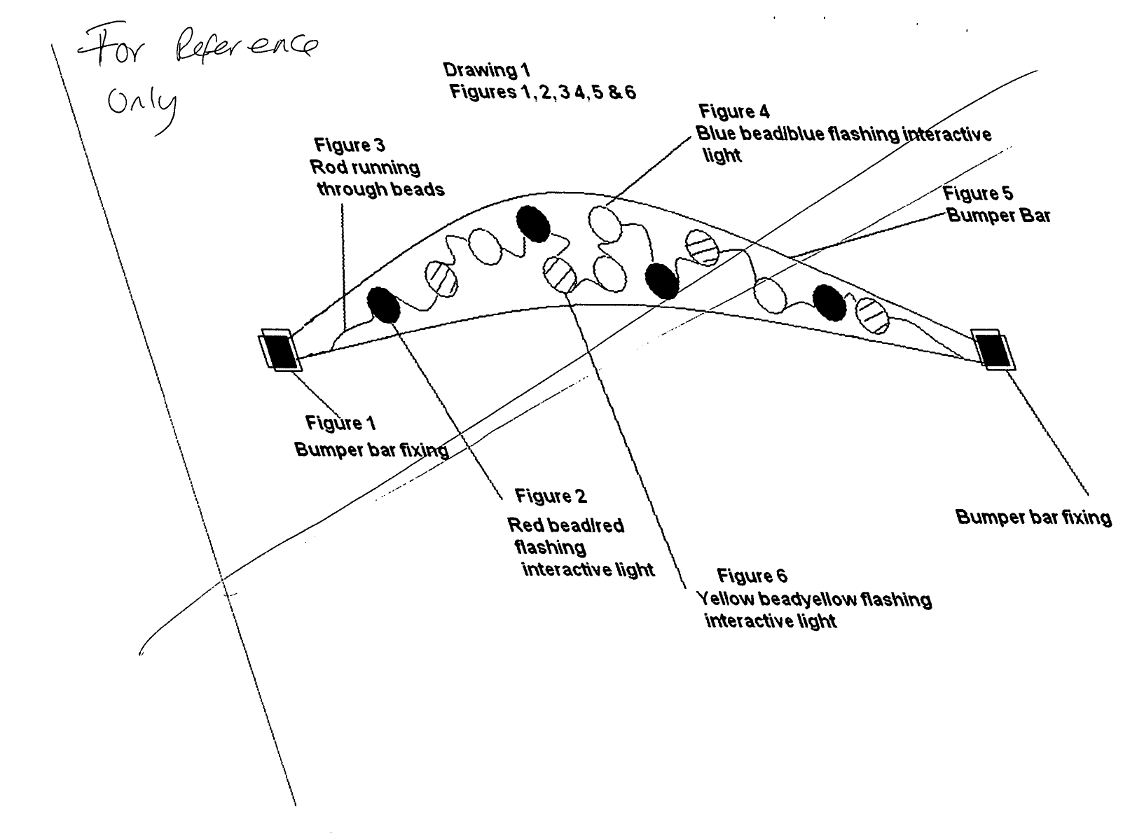

FIG. 1: A fixing for the bumper bar which attaches onto the front of the stroller seat that is able to rotate to allow the bumper bar toy to face the seats chosen position.

FIG. 2: Red beads/interactive flashing light beads repeated 4 times over integrated onto the bumper bar.

FIG. 3: Rod running through the beads which have hollow insertions.

FIG. 4: Blue beads/interactive flashing light beads repeated 4 times over mounted onto the bumper bar.

FIG. 5: Bumper bar.

FIG. 6: Yellow beads/interactive flashing light beads repeated 4 times over integrated onto the bumper bar.

1. A integrated toy for bumper bars, consisting of anything from toy's with sound or moving parts such as balls and buttons drawing 1 FIGS. 2,4 and 6 with the option of having different styles of valleys/channels for the beads to travel through

2. A integrated toy relating to claim 1 inserted within the bumper bar of the stroller with four coloured beads repeating 3 times over totaling to 12, integrated into the handle which would allow a hollow for the insertion of the toy in question; beads consisting of colour's: red, blue, and yellow, on a twisted rod for entertainment/educational purpose, see drawing 1 with the option of having different styles of valleys/channels for the beads to travel through

3. A stroller bumper bar toy relating to claims 1 and 2 which could also consist of musical or interactive balls and as such a toy attached for stroller seat's for entertainment purpose having a channel with different styles of valleys/channels for the beads to travel through.
